(19) United States
(12) Patent Application Publication
(10) Pub. No.: US 2016/0331001 A1
(43) Pub. Date: Nov. 17, 2016

(54) Snack of Animal Origin and Production Method

(71) Applicant: Evans Food Products Company, Chicago, IL (US)

(72) Inventors: Arturo Carlos Gutierrez de Velasco Alvarez, Tinley Park, IL (US); Alejandro Silva Platt, Chicago, IL (US); Hector Guerra Fausti, Chicago, IL (US)

(21) Appl. No.: 14/812,561

(22) Filed: Jul. 29, 2015

Related U.S. Application Data
(60) Provisional application No. 62/161,037, filed on May 13, 2015.

(51) Int. Cl. A23L 1/311; A23B 4/14; A23L 1/314; A23B 4/12

(52) U.S. Cl. CPC A23L 1/311; A23B 4/12; A23B 4/14; A23L 1/31445; A23V 2002/00

(57) ABSTRACT

A method for preparing a snack item including the steps of providing a raw material of animal origin, reducing the size of the raw material into discrete units, combining the discrete units with additional ingredients to form a mixture, cooling the mixture to a temperature at or below the dew point of the mixture and baking the mixture at a temperature from about 150° C. to 190° C., for about 15 seconds to 90 seconds to form a snack product with a high protein content.

### RELATED APPLICATION DATA

This application is a non-provisional of U.S. Provisional Patent Application No. 62/161,037 filed May 13, 2015, the entirety of which is incorporated herein by reference to the extent permitted by law.

### FIELD OF THE INVENTION

The present invention relates generally to food products and to their methods of preparation. In particular, the present invention relates to a process for preparing a snack of animal origin and the product produced by the process.

### BACKGROUND OF THE INVENTION

Snack foods such as potato chips and tortilla chips allow a consumer to have convenient snack food with a crisp texture. These kinds of snack foods generally have high calories, fat, and cholesterol because they employ manufacturing processes that fry the product in oil. Recent dietary and nutritional trends have led people to replace high calorie, carbohydrate and fat content snack items in favor of higher protein snack items containing meat such as pork rinds and jerky products.

While pork rinds have more protein than other traditional snack items they still have a high fat content. Jerky products may be viewed as a suitable alternative to pork rinds because the have lower fat content than pork rinds and other traditional snack chip items, but jerky products are high in sodium and preservatives and often lack the crisp texture and taste of a chip, which tends to be preferred by consumers.

Additionally, as is known in the industry, meat is particularly susceptible to oxidation because of its high lipid content. Therefore, products that incorporate meat can become rancid over time as a result of the oxidation of lipids in the meat product. Gray, J. I. (1978). Measurement of lipid oxidation. A review. J. Am. Oil Chem. Soc., 55, 539-46 (incorporated by reference). Meat based products, therefore, tend to have a shorter period of time for which the snack will retain an acceptable level of eating quality from a safety and sensory point of view than other snack items that do not include meat.

This period of acceptable level of eating quality is also referred to as shelf life and methods for measuring shelf-life such as Accelerated shelf-life testing (“ASLT”) are well known. Additional information on shelf-life is set forth in “Ways of Measuring Shelf-life and Spoilage,” (R. Steele ed., Woodhead Publishing Series in Food Science, Technology and Nutrition 2004) and Antonio Valero, Elena Carrasco and Rosa Ma Garcia-Gimeno (2012) “Principles and Methodologies for the Determination of Shelf-Life in Foods, Trends in Vital Food and Control Engineering,” Prof. Ayman Amer Eissa (Ed.), ISBN: 978-953-51-0449-0, InTech, Available from: http://www.intechopen.com/books/trends-in-vitalfood-and-control-engineering/principles-and-methodologies-for-the-determination-of-shelf-life-in-foods,” which are hereby incorporated by reference.

Factors that affect oxidation in meat systems and that can vary the shelf life of a meat based product include heat, exposure to light, metal ions, storage time, preservatives, freezing, salts, pH, enzyme activity and exposure to air or oxygen. McMillin, K. W. (1996). “Initiation of oxidative processes in muscle foods.” In: 49th Annual Reciprocal Meat Conference: 1996 Chicago, Ill.: American Meat Science Association (hereby incorporated by reference). A combination of increased temperature and longer time, will result in higher lipid oxidation (and a reduced shelf-life), as commonly measured using the 2-thiobarbituric acid test (TBA) developed by Tarladgis et al. (1960) or slightly modified versions of this method. Tarladgis, B. G., B. M. Watts, M. T. Younathan, and L. R. Dugan, Jr., (1960). “A distillation method for the quantitative determination of malonaldehyde in rancid flavor.” J. Am. Oil Chem. Soc. 37:44-48. (hereby incorporated by reference). While the shelf-life of product can be manipulated using these known factors, the taste and other sensory factors may be affected resulting in a product with a long shelf-life but reduced taste, texture and appearance.

Accordingly, there is a need for a protein rich snack with a lower fat content and improved shelf life.

### SUMMARY OF THE INVENTION

Disclosed herein are methods for preparing a snack item. The methods may include providing a raw material of animal origin, reducing the size of the raw material into discrete units, combining the discrete units with additional ingredients to form a mixture, cooling the mixture to a temperature at or below the dew point of the mixture and baking the mixture at a temperature from about 150° C. to 190° C., both inclusive for about 15 seconds to 90 seconds, both inclusive to form a snack product with a high protein content. The method additionally may include baking the mixture in a in double belt oven or in a wafer oven.

In some embodiments, pressure can be applied to the mixture during the baking process. The pressure can vary according to the oven type. For example, the pressure can be in the range of about 100 to 500 pounds per square inch in a double belt oven or about 300 to 1,000 pounds per square inch in a wafer oven.

In some embodiments the raw material can be selected from a group consisting of beef, pork, lamb, chicken and turkey. In some embodiments flavorings and preservatives can be added to the mixture. In other embodiments the preservatives can be added in an amount to extend the snack product shelf life to about 150 days.

Other systems, methods, features, and advantages of the present invention will be or will become apparent to one with skill in the art upon examination of the following figures and detailed description. It is intended that all such additional systems, methods, features, and advantages be included within this description, be within the scope of the invention, and be protected by the accompanying claims.

### BRIEF DESCRIPTION OF THE DRAWINGS

The accompanying drawings, which are incorporated in and constitute a part of this specification, illustrate an implementation of the present invention and, together with the description, serve to explain the advantages and principles of the invention. In the drawings:

FIG. 1 is a block diagram illustrating a method to prepare a snack of animal origin according to an embodiment of the invention.

FIG. 2 is a block diagram illustrating a bake step according to an embodiment of the invention.

### DETAILED DESCRIPTION OF THE PRESENTLY PREFERRED EMBODIMENTS

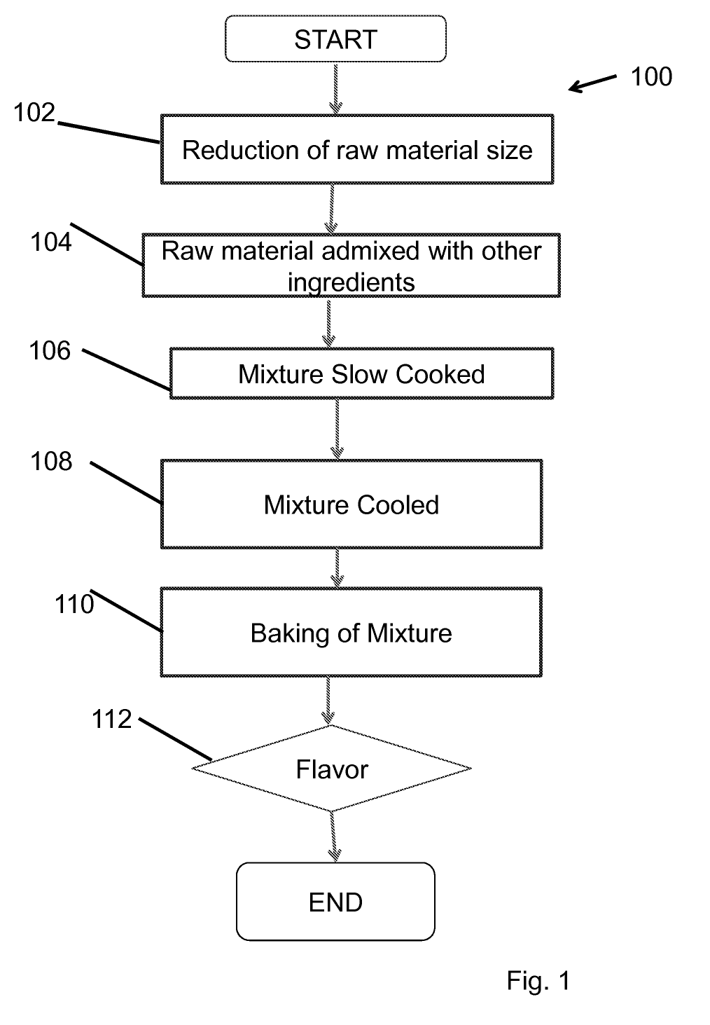

FIG. 1 is a functional block diagram 100 illustrating the different components used in a method of making a snack of animal origin 100. It should be understood that block diagram 100 can include less steps, more steps, or different steps depending on the desired end product. In these embodiments, one or more steps may be performed in parallel or in a sequence different from that depicted in FIG. 1.

As shown in FIG. 1, method 100 begins with step 102, when the raw materials of animal origin such as beef, pork, lamb, chicken, fish, turkey are reduced in size by cutting, dicing, or grinding the raw material into smaller discrete units. In an example, the raw material is a pork skin, other animal tissues or muscles, or a combination of more than one kind animal origin raw material. The smaller discrete units of the raw material of animal origin can be reduced to an average size of 0.25 inches per side up to 3.5 inches per side. Preferably the discrete units contain a substantially fibrous morphology of the raw material. In an example the discrete units are cubed, however the sides of the discrete units do not have to be uniform in length. Method 100 then advances to step 104.

At step 104, the discrete units of the raw material of animal origin are admixed with other ingredients in a cylindrical drum mixer with eccentric mixing paddles to ensure uniform blending of the ingredients and the raw material of animal origin. Other known mixing methods may also be employed to admix the discrete units of the raw material of animal origin and other ingredients. The other ingredients are weighed or measured in appropriate amounts and then added to the mixer. In an example, the other ingredients may be salt, pepper, natural smoke flavor, sugar, spices (dry or liquid) or the like, or any combination of them. In an example, the discrete units of raw material of animal origin are added in an amount from about 75 wt % to 90 wt % (of the mixture) and other ingredients from about 10 wt % to 25 wt % (of the mixture).

At step 104, natural and/or artificial preservatives can also be added to the mixture as additional ingredients to stabilize the product by preventing fat oxidation/rancidity and increase the sustained shelf life of the resulting product at room temperature. Such preservatives can include Butylated Hydroxy Toluene (BHT), Treitiary Butyl Hydro Quinone, (TBHQ), rosemary extract, ascorbic acid, polypheonol antioxidant, chicoric acid, chlorogenic acid, cinnamic acid and its derivatives such as ferulic acid, ellagic acid, ellgitannins, gallic acid, gallotannins, rosmarininc acid, salicylic acid or the like. All preservatives may be used in an amount based on USDA and FDA regulations such as between about 0.05 wt % to 2 wt % of the product. The preservatives can be added in amounts such that the shelf life of the product more than 30 days, more than 45 days, more than 60 days, more than 75 days, more than 90 days, more than 105 days, more than 120 days, more than 135 days, more than 150 days, more than 165 days or more than 180 days. The formula for deferring the correct amounts needed to obtain a set shelf life date are well known. Additionally, the amount of preservatives added and desired shelf-life can factor in other processing steps that are known to impact shelf-life. All of the elements are mixed for at least 20 to 60 minutes. In a preferred example the elements are mixed for about 20 minutes. Method 100 then advances to step 106.

At step 106, the resulting mixture is then slow cooked for a minimum of 30 minutes in a steam jacketed vessel at above 80° C. Such steam vessels may include multi-zone jacketing, vacuum pressure options, single-motion, double-motion or twin action agitators. In an example, the mixture is slow cooked for an amount of time between about 30 and 90 minutes, both inclusive. In an example, the mixture is slow cooked for about 30 to 40 minutes, both inclusive; about 40 to 50 minutes, both inclusive; about 50 to 60 minutes, both inclusive; about 70 to 80 minutes both inclusive; or about 80 to 90 minutes, both inclusive. In a preferred example it was determined that if the mixture is slow cooked at about 80° C. for about 30 to 40 minutes, both inclusive, the lipids present in the mixture do not oxidize which increases the end product's shelf life. In operation the steam jacketed vessel may be implemented using a Groen Process Steam Jacketed Kettle. Method 100 then advances to step 108.

At step 108 the mixture is cooled to a temperature below the dew point of the product to prevent condensation of the mixture. In an example, this is below 72° C., however as is well known, the exact temperature of the dew point may vary based on the existing room and mixture conditions such as humidity, air temperature and mixture temperature for at least 30 minutes. Once the mixture is cooled, the mixture can be packed within a container without condensation of water inside the container. The mixture can also be prepared for forming after the cooling step. In an example, the mixture is feed into a depositor machine that deposits an amount of the mixture through a set of nozzles to an underlying surface. The mixture can then be pressed or molded into a desired shape for further processing. In an example, the mixture can be flattened or formed into a small flat cake e.g. a patty, formed into a chip, or a pork rind shape. In an example, a shaped molding roller can be employed with cavities of uniform or varying shapes to provide a mixture in a desired shape. Machines that perform such product formation are well known. Method 100 then advances to step 110.

At step 110 the mixture is baked at a low temperature for a short period of time. At step 110, the baking process removes moisture from the blended mixture through the application of direct heat and intermittent pressure and dehydrates the blended product resulting in a crispy product without the need of frying. As described below, optional parameters such as product, thickness, baking temperature, baking time, application of pressure and oven type can be varied individually or in combination with each other to achieve desired characteristics of the product such as crispness.

The product thickness before the product is placed in the oven can vary from about 2.5 mm to 8.0 mm, both inclusive. Since the thickness of the product may affect the baking temperature, baking time, applied pressure or any combination of the foregoing, it is preferred that the average product thickness of a particular batch is generally the same so that the baked product has the same characteristics.

The product in step 110 can be baked in an oven (which are well known) at a temperature in the range from about 150° C. to 190° C., both inclusive. In an example the temperature can be about 150° C. to 160° C., both inclusive; about 160° C. to 170° C., both inclusive; about 170° C. to 180° C., both inclusive; or about 180° C. to 190° C., both inclusive.

The product in step 110 may be baked for a period of time, which may be predetermined. In an example, the blended mixture can be baked at a temperature within the range of about 150° C. to 190° C. as described above for about 15 to 20 seconds, both inclusive; about 20 to 25 seconds, both inclusive; about 25 to 30 seconds, both inclusive; about 30 to 35 seconds, both inclusive; about 35 to 45 seconds, both inclusive, about 45 to 55 seconds, both inclusive, about 55 to 60 seconds, both inclusive; about 60 to 65 seconds, both inclusive; about 65 to 70 seconds, both inclusive; about 70 to 75 seconds, both inclusive; about 75 to 80 seconds, both inclusive; about 80 to 85 seconds both inclusive; or about 85 to 90 seconds both inclusive. Generally, the lower the temperature of the baking step the longer time period for baking and likewise the higher the temperature of the baking step the shorter the time period for baking.

Pressure can also be applied to the product during the baking process. When pressure is applied, the initial thickness of the product is reduced which can reduce the necessary bake time and also increase the crispiness of the end product. The amount of pressure varies based on the type of oven used. Regardless of the oven, the pressure may be applied towards the beginning of the baking step 110 for a short period of time. The pressure may also be applied intermittently throughout the baking step 110 at equal internals for the same amount of time or at different intervals for the same or different amounts of time. Application of pressure on an intermittent basis allows the product to expand throughout the baking step 110 resulting in a puffed or enlarged product. Conversely, pressure can be applied in a manner that would result in a substantially flat product by increasing the duration of the pressure, the amount of the pressure, applying pressuring towards the end of the baking process, or a combination of any of the foregoing. In an example, the pressure is applied to the product after about the first 15 seconds of the baking step 110 for about 1 to 15 seconds and then the pressure is released. In another example where the baking time is 60 seconds, pressure can be applied after the first 15 seconds of the baking step for about 1 to 3 seconds and pressure can be applied again at 30 to 33 seconds into the baking step for about 1 to 3 seconds and then the pressure is released and the product is allowed to bake for the remainder of the 60 second time period.

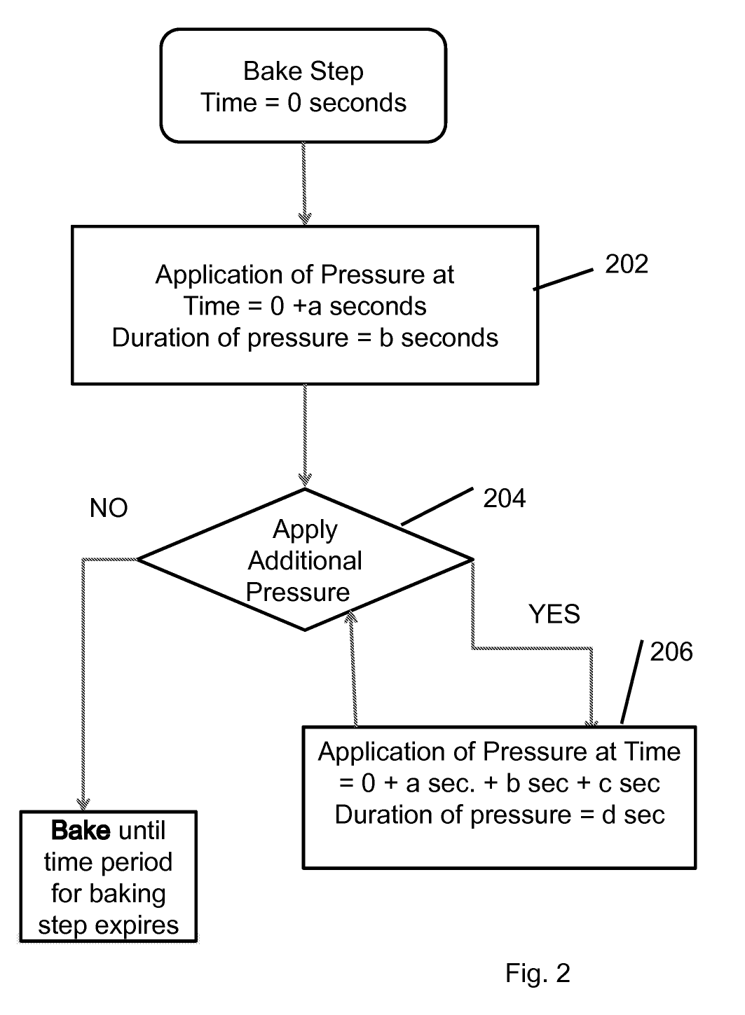

FIG. 2 shows an example of how pressure can be applied during the baking step 110. In step 202 pressure is applied at a time “a” seconds after the start of the baking step for a for a duration in an amount of “b” seconds. Step 202 proceeds to Step 204. If additional pressure is applied step 204 proceeds to step 206. At step 206, pressure is applied at a time equal to the total amount of “a”+“b”+“c” where “c” is equal to an amount of additional bake time between the application of the first pressure and the application of the second pressure. Further, “c” can be the same or different from the value of “a”. The pressure in this step 206 is applied for a duration in an amount of “d” seconds which can be the same amount of seconds as “b” or different than the amount of seconds as “b”. While not shown in this figure it is understood that pressure can be applied once, twice, or more throughout the bake step 110. The intervals of the pressure application can be equal and last for the same amount of time or the intervals for the pressure application can be different from each other lasting for the same amount of time or different amounts of time. At step 204 if no additional pressure is added, the product is allowed to bake until the time period for the baking step 110 expires.

The baking in step 110 can be done using double belt oven that affords simultaneous processing of the top and bottom of the product between the baking belts. The gap between the belts can be adjusted to accommodate different sized products discussed above. In an example, the gap can be adjusted to accommodate a product having a thickness from about 2.5 mm to 8.0 mm, both inclusive. The thickness of the product can be about 2.5 mm, about 3.0 mm, about 3.5 mm, about 4.0 mm, about 4.5 mm, about 5.0 mm, about 5.5 mm, about 6.0 mm, about 6.5 mm, about 7.0 mm, about 7.5 mm, or about 8.0 mm.

Pressure can also be applied to the product in an amount ranging from about 100 to 500 pounds per square inch (“psi”), both inclusive for a period of about 1 to 3 seconds, both inclusive at a point or points in the baking process. The amount of pressure applied can be from about 100 to 150 psi, both inclusive; about 150 to 200 psi, both inclusive; about 200 to 250 psi, both inclusive; about 250 to 300 psi, both inclusive; about 300 to 350 psi, both inclusive; about 350 to 400 psi, both inclusive; about 400 to 450 psi, both inclusive; about 450 to 500 psi, both inclusive. The pressure can be applied at time periods and for durations as described above. In operation this baking step can be implemented using Berndorf double belt technology or the like.

In another example, the baking step 110 is done in a wafer baking oven that affords simultaneous processing of the top and bottom of the product between baking plates. The gap between the plates can be adjusted to accommodate different sized products. In an example, the gap can be adjusted to accommodate a product having a thickness from about 2.5 mm to about 8.0 mm, both inclusive. The thickness of the product can be about 2.5 mm, 3.0 mm, 3.5 mm, 4.0 mm, 4.5 mm, 5.0 mm, 5.5 mm, 6.0 mm, 6.5 mm, 7.0 mm, 7.5 mm, or 8.0 mm. In an example, pressure in an amount of about 300 to 1000 pounds per square inch, both inclusive can be applied to the product at a point or points in the baking process 1 to 30 seconds. In an example, the amount of pressure applied can be from about 300 to 350 psi, about 350 to 400 psi, about 400 to 450 psi, about 450 to 500 psi, about 500 to 550 psi, about 550 to 600 psi, about 600 to 650 psi, about 650 to 700 psi, about 700 to 750 psi, about 750 to 800 psi, about 800 to 850 psi, about 850 to 900 psi, about 900 to 950 psi, about 950 to 1,000 psi. The pressure can be applied at time periods and for durations as described above. In operation this baking step can be implemented using Hebenstreit Wafer Machines, Gocmen Wafer ovens, Walterwerks Wafer Machines or the like.

In a preferred example, with the above parameters in mind the product has a thickness of about 3 mm thickness and is baked at a temperature of about 170° C. for about 50 seconds. In this example pressure may be applied after fifteen seconds of baking for about 1 to 3 seconds. Optionally, pressure can be applied again after 38 seconds of total bake time for about 1 to 3 seconds and then the product can bake for the duration of the 50 second baking time.

At step 110 a snack product having a crisp texture is produced. Crispness or crispy food products are manifested in structural, mechanical and surface properties of foods and is often identified through sensory evaluation e.g. feel and auditory characteristics. As described in “Application of Fracture Mechanics to The Texture of Food,” which is hereby incorporated by reference, crispness is a textural or sensual experience in eating a food item which fails in a brittle manner at a lowish load. Julian F V Vincent, “Application of Fracture Mechanics to the Texture of Food,” (Anales De Mecanica De la Fractura, Vol. 20 2003). Crisp materials are generally brittle stiff materials with little moisture. In an example, the resulting shape and size of the snack product is based on how the mixture is prepared for forming. For example, the snack product may have a small flat cake shape, a shape of a pork rind, chip or the like. Method 100 then advances to step 112.

At step 112, the resulting crispy product may be seasoned in the known way with a desired flavor including buffalo, ranch, barbeque, cheese, flavorless or the like. Oils can be added to adjust the palatability, like olive oil, sunflower oil, truffle oil and the like. In an example, preservatives can also be added to the seasoning.

The resulting crispy product has a high protein content of 50% or greater, or in the range of about 50% to 75%. In an example the protein content is about 50% to 55%, about 55% to 60%, about 60 to 65%, about 65% to 70% or about 70 to 75%. Protein content can be measured by Kjeldahl method, which is a known protein measurement standard.

The crispy product may then be allowed to cool and packaged. In packaging the crispy product is placed into a bag which could be premade or formed using manual, semiautomatic and automatic packaging equipment, and subjected to various quality control checks and then prepared for shipping. Other suitable packing methods known to those of ordinary skill in the art may also be employed.

While various embodiments of the present invention have been described, it will be apparent to those of skill in the art that many more embodiments and implementations are possible that are within the scope of this invention. Accordingly, the present invention is not to be restricted except in light of the attached claims and their equivalents.

What is claimed is:

1. A method for preparing a snack food comprising the steps of:
(a) providing a raw material of animal origin;
(b) reducing the size of the raw material into discrete units;
(c) combining the discrete units with at least one additional ingredient to form a mixture;
(d) cooling the mixture to a temperature at or below the dew point of the mixture; and
(e) baking the mixture at a temperature from about 150° C. to 190° C., both inclusive for about 15 seconds to 90 seconds, both inclusive to form a snack product.

2. The method according to claim 1 wherein the raw material is selected from a group consisting of beef, pork, lamb, chicken, fish and turkey.

3. The method according to claim 1 wherein the mixture is baked in a double belt oven.

4. The method according to claim 1 wherein the mixture is baked in a wafer oven.

5. The method according to claim 3 wherein pressure in an amount of about 100 to 500 pounds per square inch, both inclusive, is applied to the product fifteen seconds after the baking step begins for about 1 to 3 seconds.

6. The method according to claim 4 wherein pressure in an amount of about 300 to 1,000 pounds per square inch, both inclusive, is applied to the product fifteen seconds after the baking step begins for about 1 to 3 seconds.

7. The method according to claim 1 wherein the additional ingredient includes a preservative.

8. The method according to claim 7 wherein the preservative is at least one selected from a group consisting of Butylated Hydroxy Toluene (BHT), Treitiary Butyl Hydro Quinone, (TBHQ), rosemary extract, ascorbic acid, polypheonol antioxidant, chicoric acid, chlorogenic acid, cinnamic acid, cinnamic derivatives and, salicylic acid.

9. The method according to claim 8 wherein the preservative is added in an amount such that the snack product has a shelf life of about 150 days.

10. The method according to claim 1 wherein the snack product has a protein content in the range of about 50% to 75%, both inclusive.

11. The method according to claim 1 wherein the additional ingredient is at least one selected from the group consisting of salt, pepper, natural smoke flavor, and sugar.
